(19) United States
(12) Patent Application Publication
(10) Pub. No.: US 2003/0146171 A1
(43) Pub. Date: Aug. 7, 2003

(54) Liquid and solids separation apparatus and method with continuous cleaning using defferential pressure control

(76) Inventor: Karl-Heinz Herrmann, Midlothian, VA (US)

Correspondence Address: GOODMAN, ALLEN & FILETTI PLLC, 4501 HIGHWOODS PARKWAY, SUITE 210, GLEN ALLEN, VA, 23060, US

(21) Appl. No.: 10/061,291

(22) Filed: Feb. 4, 2002

(51) Int. Cl. B01D 35/143

(52) U.S. Cl. 210/741; 210/797; 210/107; 210/108; 210/411

(57) ABSTRACT

This invention comprises a method and an apparatus for separating solids from fluids in fluids containing high total suspended solids and where the solids are of a broad particle size including ultra fine particles. A fluid volume is passed through a filter element thereby separating the solids from the liquid. The solids deposited on and in the filter element are cleaned from the filter element by a continuous backwashing process using pressurized filtered fluid in excess of the fluid pressure of the fluid on the intake side of the filter. The rate at which backwashing occurs and the pressure of the pressurized filtered fluid used in backwashing is increased when the pressure differential between the intake and outlet volumes increases.

### CROSS-REFERENCE TO RELATED APPLICATIONS

This application claims priority from U.S. Provisional Application No. 60/266,278, “Multistage Liquid and Solids Separation Apparatus and Method with Continuous Cleaning Using Differential Pressure Control.”

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

This invention relates to a method and an apparatus for separating solids from various fluids in which said solids are suspended and especially to filters for separating solids from a fluid containing high total suspended solids and/or where the solids vary broadly in particle size and include particles as small as 0.2 microns.

In a traditional filter apparatus, contaminated fluid from an initial volume is passed through a filter media. Solids are separated out of the fluid and the filtered fluid is received on the outlet side of the filter media. Efficiency and capacity are the two primary measures of a filter's operation. Efficiency is the measure of the purity of the final product. Capacity refers to the rate at which material can be passed through the filter and processed without a commensurate loss in efficiency. Regardless of the type of filtration used (e.g. deep-bed filtration, cake filtration, etc.) as time progresses solids separated from the fluid accumulate on or in the filter media, and either one or both of these two operating parameters begin to decline until a point is reached where the filter is no longer economical to operate. At this point, the filtering process must be stopped and the filter media must either be cleaned or replaced.

Many filtering systems use an automated cleaning process that requires that the filtering system be taken off-line. The pressure on the inlet and outlet sides of the filter is monitored and when the difference in these pressures exceeds a preset value, indicating that the capacity of the filter has dropped below an acceptable level, the filter apparatus is then shut down and cleaned by backwashing the filter media. Backwashing, as used here, refers the process of passing fluid through the filter media in the direction opposite to the flow during filtration in order to dislodge solids which have accumulated on or in the filter media during filtering.

Conventional one-stage filters are not well suited to filter liquids with solids with a broad range of particle sizes distributed therein or fluids containing a high solid to liquid ratio. Because the filter media in such filters must have a pore size small enough to intercept the smallest particles which must be filtered, such filters become quickly clogged and require frequent cleaning. Multi-stage filters, which include several filter elements with filter media of progressively finer pore size ameliorate this effect, but still require frequent cleaning. It is most advantageous to have a filter system that does not need to be shut down on a regular basis in order to be cleaned or replaced.

There are several types of continuous backwash filters disclosed by the prior art. These devices permit cleaning of the filter media by backwashing during the normal operation of the filtering process. The most basic of these is exemplified by U.S. Pat. No. 4,085,051 (Kaminsky '051) disclosing a filter apparatus wherein backwashing devices or shoes abut the filter media on the inlet side. These shoes are rotated around the central vertical axis of the annular filter media. Backwashing in this apparatus relies on a pressure differential between the backwash fluid discharge and the outlet chamber of the filter apparatus. So long as the pressure of the fluid in the outlet chamber of the apparatus exceeds the pressure in the backwashed fluid outlet, a portion of the filtered fluid backwashes the filter media by moving from the outlet chamber through the filter media and into the shoes on the inlet side of the filter media. One problem with this apparatus is that there must be a substantial amount of filtered fluid in the outlet chamber in order to sustain the pressure differential necessary for backwashing to occur. If the filter element becomes clogged prior to the accumulation of sufficient filtered fluid then the backwash feature will not operate because the pressure in the outlet chamber will be inadequate to force fluid through the filter media and into the shoes.

An additional problem with the apparatus of Kaminsky '051 is that maintaining an adequate seal between the filter means and the rotating backwash devices is necessary, but difficult. It follows from the design of such an apparatus that the fluid pressure in the inlet chamber must always exceed the fluid pressure in the outlet chamber. In turn, the fluid pressure in the outlet chamber must exceed the fluid pressure in the backwashing devices. There is thus a substantial pressure differential between the inlet chamber fluid pressure and the fluid pressure in the backwashing devices.

As the pressure in the inlet chamber of the apparatus in Kaminsky '051 is increased, unfiltered fluid may be forced into the backwashing devices. This compromises filtering capacity of the apparatus or “short-circuits” filtering because unfiltered fluid escapes through the backwashing fluid outlet. It also compromises the backwashing process because it decreases the pressure differential between the fluid pressure in the outlet chamber and fluid pressure in the backwashing devices. Less unfiltered fluid flows through the filter media to the outlet chamber and the pressure in the outlet chamber is thus decreased and the flow of unfiltered fluid into the backwashing devices increases the pressure in the backwash fluid discharge. Flow from the outlet chamber through the filter media to the backwashing devices is thus decreased.

This inventor's prior U.S. Pat. No. 5,128,029 (Hermann '029) attempts to solve the problem of insufficient fluid for backwashing in a continuously backwashing filter by using a filtered fluid retention plate on the outlet side of the filter means. However, the apparatus of Hermann '029, as the other prior art devices, requires that a proper seal be maintained between the sliding shoe and the filter means. If the seal is broken, unfiltered fluid under high pressure will leak into the sliding shoe and be removed with the backwash. Thus, the apparatus of Hermann '029 suffers from problems similar to those discussed above as to the device of Kaminsky '051.

The apparatus and method disclosed by U.S. Pat. No. 6,136,202 (Foreman '202) also attempts to solve the problem of insufficient fluid and inadequate outlet chamber pressure for continuous backwashing by pressurizing the outlet chamber fluid volume to a pressure less than the inlet chamber fluid volume pressure, but greater than the backwashed fluid outlet pressure. However, increasing the outlet chamber pressure without a corresponding increase in the inlet chamber volume pressure decreases the capacity of the filter because the pressure differential between the inlet and outlet chamber is diminished. This effect might be ameliorated by increasing the inlet chamber pressure but doing so will also short-circuit filtering by breaking the seal between the backwash shoe and the filter media. Thus the apparatus of Foreman '202 increases backwashing with a reduction in filter capacity and still poses the same difficulties as other prior art devices as regards the seal between the backwash shoe and the filter media.

### SUMMARY OF THE INVENTION

It is an object of the invention to provide a filter method and filter apparatus having a high capacity and efficiency.

It is another object of the invention to provide a filter method and filter apparatus capable of filtering fluid having high total suspended solids and fluids containing solids with a broad range of particle sizes including particles as small as 0.2 microns, while maintaining a high volume of filtered fluid on a continuous basis.

An additional object of the invention is to provide a filter method with continuous backwashing of the filter media without substantially diminishing the capacity or efficiency of the filter during operation.

It is a further object of the invention to provide a filter apparatus with continuous backwashing that occurs at a pressure in excess of the pressure of the inlet chamber and outlet chamber.

It is also an object of the invention to provide a filter apparatus with continuous backwashing in which the backwashing fluid pressure and the rate of backwashing is increased when the pressure differential between the inlet and outlet volumes is increased.

It is another object of the invention to provide a filter method and filter apparatus with continuous backwashing which does not allow contaminated fluid to short-circuit filtering.

It is an additional object of the invention to provide a filter apparatus with a small footprint.

These and all other objects of the invention are achieved by a high capacity filter apparatus that utilizes continuous backwashing of the filter media at a pressure in excess of the inlet pressure. In accordance with one embodiment, the filter apparatus comprises a cylindrical filter housing closed at both ends in which a filter table identical in shape to the cross-section of the housing is affixed to the interior wall of the housing. The filter table divides the housing into an inlet chamber and an outlet chamber. The inlet chamber has an inlet for the introduction of unfiltered fluid and the outlet chamber has an outlet for the discharge of filtered fluid. The outlet chamber also includes an outlet for the discharge of a portion of the filtered fluid to a booster pump.

Filter media in an annular shape is placed upon the filter table and a filter media coverplate is affixed over the filter media on the inlet side. A plurality of perforations in the filter media coverplate and corresponding perforations in the filter table allow fluid introduced under pressure from the inlet in the inlet chamber to pass through the filter media to the outlet chamber. The filter media separates the solids from the fluid and the solids are deposited on or in the filter media.

A rotational drive shaft is provided through the center of the cylindrical housing, the filter coverplate and the filter table. The drive shaft is connected with a hydraulic motor or other suitable drive means which provides controllable rotation speed for the shaft.

Continuous backwashing of the filter media is achieved through a cleaning arm assembly on the outlet side of the filter table and a corresponding backwash collecting arm assembly on the inlet side of the filter media coverplate. The cleaning arm assembly comprises 1 or more cleaning arms which extend radially from the center of the filter table to the outer circumference of the filter table. The backwash collecting arm assembly comprises a number of backwash collecting arms equal to number of cleaning arms on the cleaning arm assembly. The backwash collecting arms extend radially from the center of the filter media coverplate to its outer circumference. The cleaning arm assembly and backwash collecting arm assembly are coupled to the drive shaft such that each arm of the cleaning arm assembly on the outlet side of the filter table is opposed by a corresponding backwash collecting arm on the inlet side of the filter media coverplate and each cleaning arm and backwash collecting arm rotate in synchrony.

Each cleaning arm and backwash collecting arm includes a shoe of suitable material which allows each cleaning arm and backwash collecting arm to slidably and sealingly abut the filter table and filter media coverplate respectively. Each shoe includes a slit which communicates with a flush channel defined by a flush channel member which extends along the radial axis of each cleaning arm and each backwash collecting arm.

Each flush channel on each cleaning arm communicates with a hollow sleeve in the outlet chamber which is disposed coaxially with the drive shaft and which extends away from the cleaning arm assembly. The hollow sleeve in the outlet chamber defines a cleaning fluid pressure chamber. An inlet to the pressure chamber is connected by conduit to the booster pump.

Each flush channel on each backwash collecting arm communicates with a hollow sleeve in the inlet chamber which is disposed coaxially with the drive shaft and which extends away from the backwash collecting arm assembly. The hollow sleeve in the inlet chamber defines a backwash rejection chamber. An outlet from the backwash rejection chamber is connected by conduit to a backwash discharge outlet in the wall of the cylindrical filter housing.

In operation, unfiltered fluid is introduced into the inlet chamber under pressure. The fluid passes through the filter media to the outlet chamber. The filter media intercepts solids which are deposited on and in the filter media. A portion of the filtered fluid, approximately 2-10%, is discharged from the outlet chamber to a booster pump. The booster pump passes this filtered fluid at a pressure exceeding the inlet chamber pressure through the cleaning fluid chamber and through each cleaning arm of the cleaning arm assembly. The fluid passes through the filter media in a direction opposite to the filtering flow, cleaning the media and dislodging solids contained in and on the filter media. The backwashed fluid and the dislodged solids are captured on the inlet side of the filter media coverplate by each backwash collecting arm corresponding to each cleaning arm and discharged through the backwash discharge outlet. In this manner the apparatus provides for the solid separation (i.e. the filtering) and the cleaning of the filter media to occur contemporaneously without a substantial decrease in filter efficiency or capacity.

In a preferred embodiment, a monitoring system is employed in order to determine the pressure in the inlet chamber and the pressure in the outlet chamber. When the difference between the inlet and outlet pressures (i.e. the pressure differential) exceeds a preset value, an automated control system increases the rotational speed of the drive shaft and/or increases the discharge pressure generated by the booster pump in order to ensure maximum efficiency of the backwash cleaning process.

According to another embodiment two or more filter housings may be coupled together such that the outlet chamber of the first filter housing communicates with the inlet chamber of the next. Such a configuration may be utilized when a more rapid cleaning of the filter is necessary and particularly when the fluid to be filtered has particles of broadly varying particle sizes. In such a configuration progressively finer filter media may be employed in each successive filtering stage.

In another embodiment, in which multiple stages are being employed, a booster pump is used to compensate for pressure loss between each filtration stage.

Further objects of the invention will become apparent to those skilled in the art from a consideration of the drawings and the detailed description that follows.

### BRIEF DESCRIPTION OF THE SEVERAL VIEWS OF THE DRAWINGS

FIG. 1 is a cross-sectional view of a three-stage embodiment of the invention.

FIG. 2 is a side view of a single stage from a three-stage embodiment of the invention with a portion of the cylindrical side wall broken away.

FIG. 3 is a cross-sectional side view of a single stage from a three-stage embodiment of the invention with all of the filter housing removed.

FIG. 4 is a side plan view of a single stage from a three-stage embodiment of the invention with the cylindrical side wall removed.

FIG. 5 illustrates a cleaning arm assembly with two cleaning arms used in a single stage of the three-stage embodiment of the invention.

FIG. 6 illustrates a cleaning fluid shaft used in a single stage of the three-stage embodiment of the invention.

FIG. 7 illustrates a backwash collecting arm assembly with two backwash collecting arms used in a single stage of the three-stage embodiment of the invention.

FIG. 8 illustrates a backwash collection shaft used in a single stage of the three-stage embodiment of the invention.

### DETAILED DESCRIPTION OF THE INVENTION

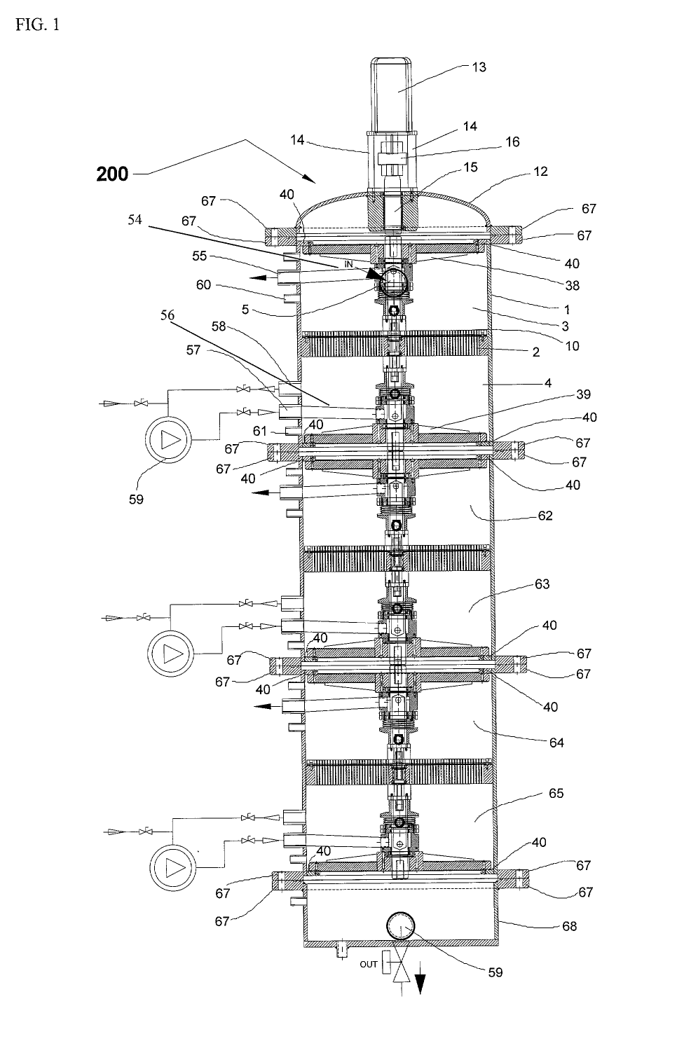

A three-stage embodiment of the invention is illustrated in FIG. 1 and indicated generally by the number 200. The first stage of the embodiment comprises a cylindrical housing 1 and a filter table 2 rigidly affixed to the housing and defining an inlet chamber 3 and an outlet chamber 4 for the first stage. An inlet 5 is provided through the cylindrical housing to admit unfiltered fluid into the first stage inlet chamber.

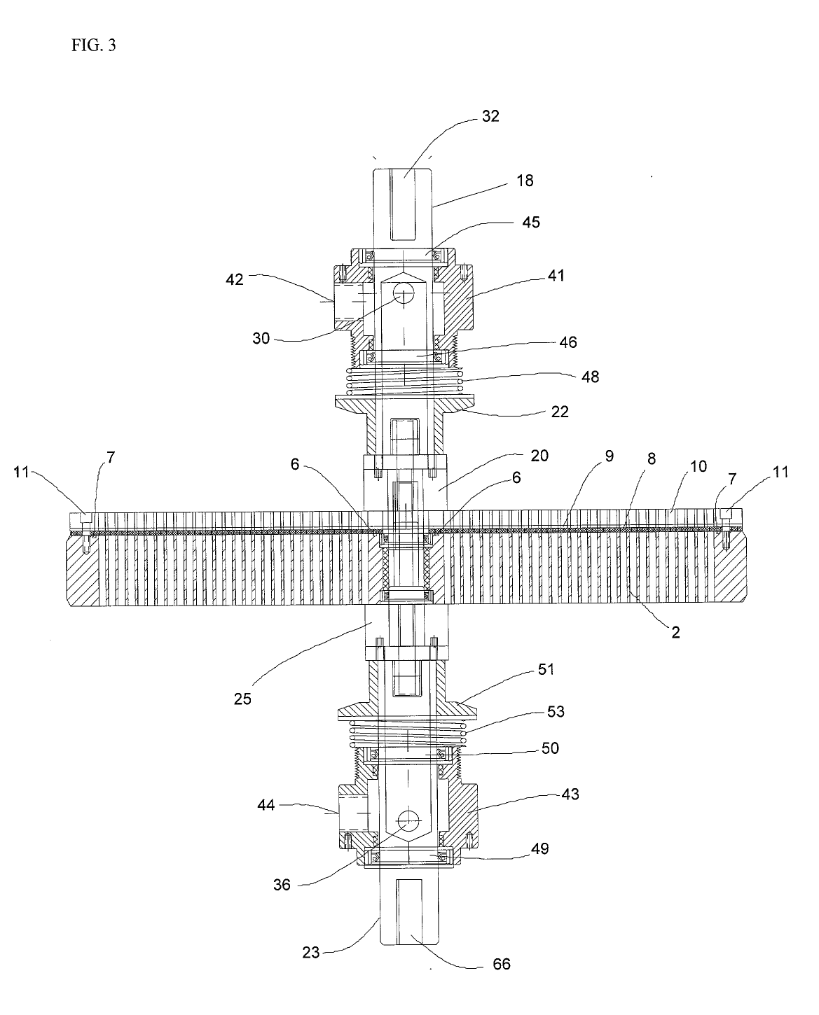

Turning now to FIG. 3, the filter table 2 has an opening at the center to accommodate the synchronous connection of the cleaning arm assembly and the backwash collecting arm assembly, both of which will be further described herein. An inner O-ring 6 is inserted in a circular slot on inlet side surface of the filter table and proximate the center opening. An outer O-ring 7 is inserted in a circular slot on the inlet side surface of the filter table and proximate the outer circumference of the filter table. The filter table has a plurality of openings throughout the annular area defined by the inner and outer O-rings. An annular filter media 8 which is slightly larger than the annular area defined by the inner and outer O-rings is placed over the filter table such that the inner circumference of the filter media extends inwardly beyond the inner O-ring and the outer circumference extends beyond the outer O-ring and to the outer circumference of the filter table. An annular elastomeric pad 9, fabricated from Viton® or other suitable material which is the same size as the filter media is placed over the filter media to prevent the filter media from dislodging during operation. The annular elastomeric pad contains a plurality of openings which are of the same size as the openings in the filter table and each opening in the elastomeric pad is located such that it communicates directly with a hole in the filter table on the opposing side of the filter media. A filter media coverplate 10 on the inlet side of the elastomeric pad is affixed to the filter table by a plurality of suitable fasteners 11 such as screws or the like. Such fasteners are located on the outer circumference of the filter media coverplate 10 and pass through the elastomeric pad 9 and the filter media 8 to the filter table 2. The filter media coverplate is affixed securely so as to compress the inner and outer O-rings against the filter media and the filter media against the elastomeric pad and such that a seal is formed at the location of the inner and outer O-rings. The filter media coverplate 10 has a plurality of openings each of which is the same size, corresponds with and directly communicates with an opening in the elastomeric pad 9 and in turn with an opening in the filter table 2. The arrangement and alignment of the holes in the filter media coverplate 10, elastomeric pad 9 and filter table 2 is such that a plurality of channels is created through which unfiltered fluid may pass from the inlet chamber 3 through each such channel and through a small portion of the filter media 8 which intercepts suspended solids permitting the now-filtered fluid to continue through the channel in the filter table 2 to the outlet chamber 4.

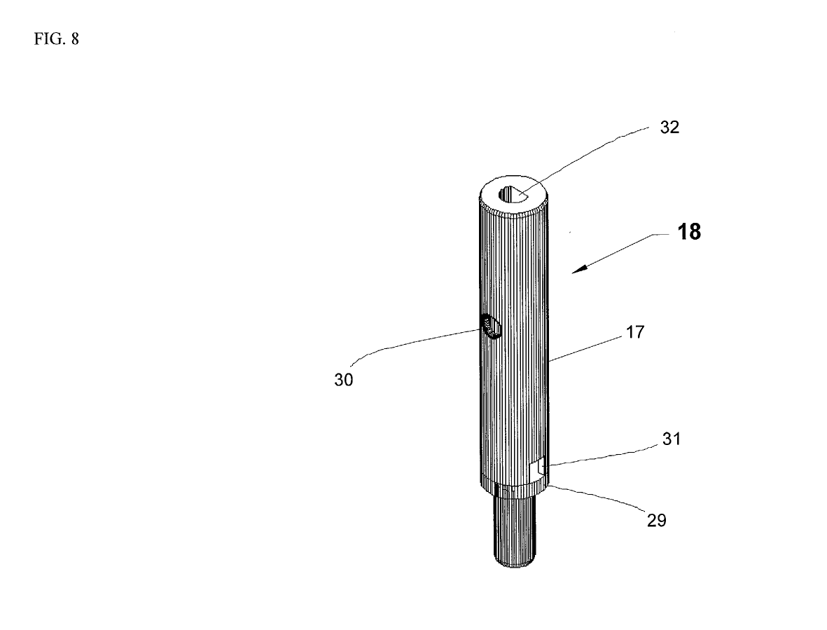

As illustrated in FIG. 1, the inlet chamber of the first stage is enclosed by a filter lid housing 12. A suitable drive means 13 for providing controllable rotational speed in the range of 3-30 RPM, such as a hydraulic motor, is affixed to motor mounting flanges 14 at the center of the filter lid housing. A drive shaft 15 is attached to the drive means 13 through a coupler 16. The drive shaft 15 is journaled in a sealed opening through the center of the filter lid housing 12 and is indexed to be received in the indexed sleeve opening 32 of the backwash collection shaft cylinder 17, illustrated in FIG. 8.

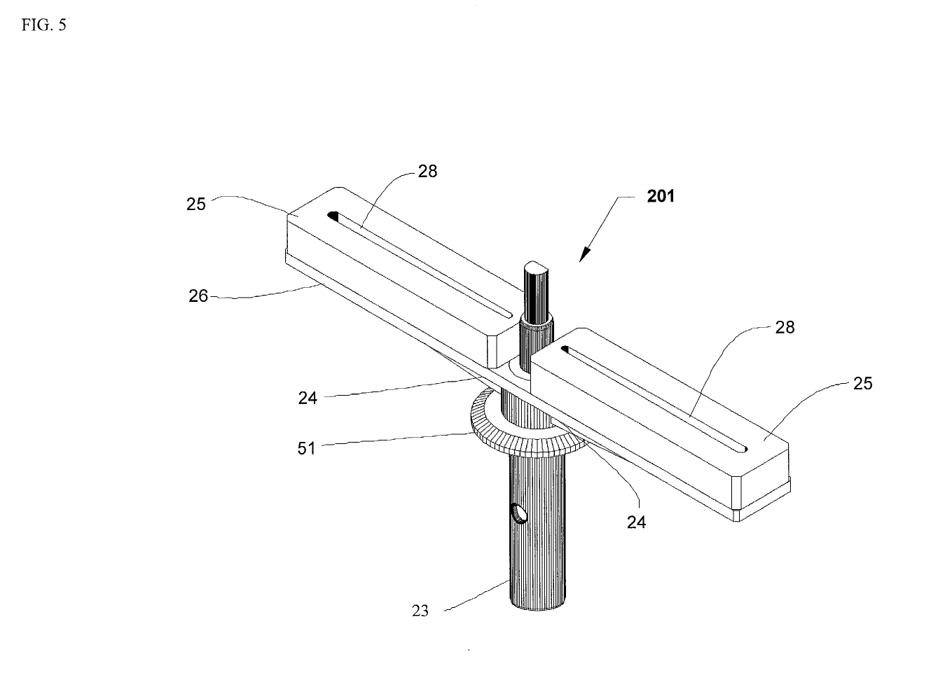

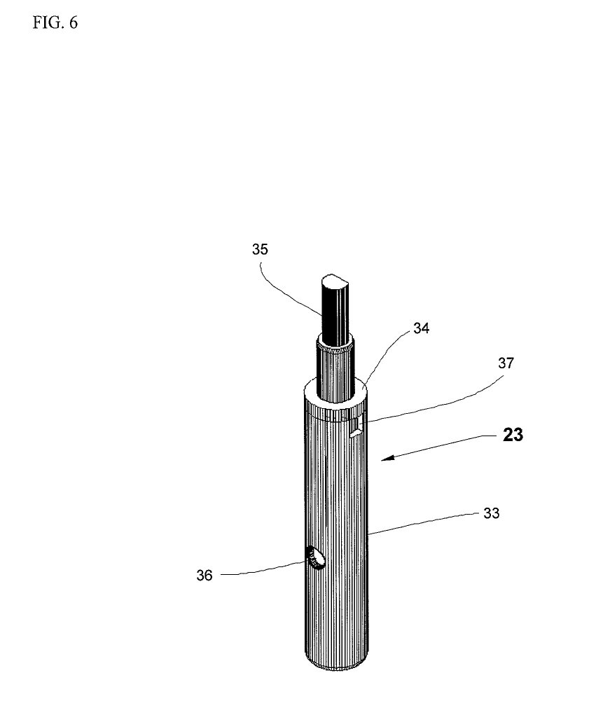

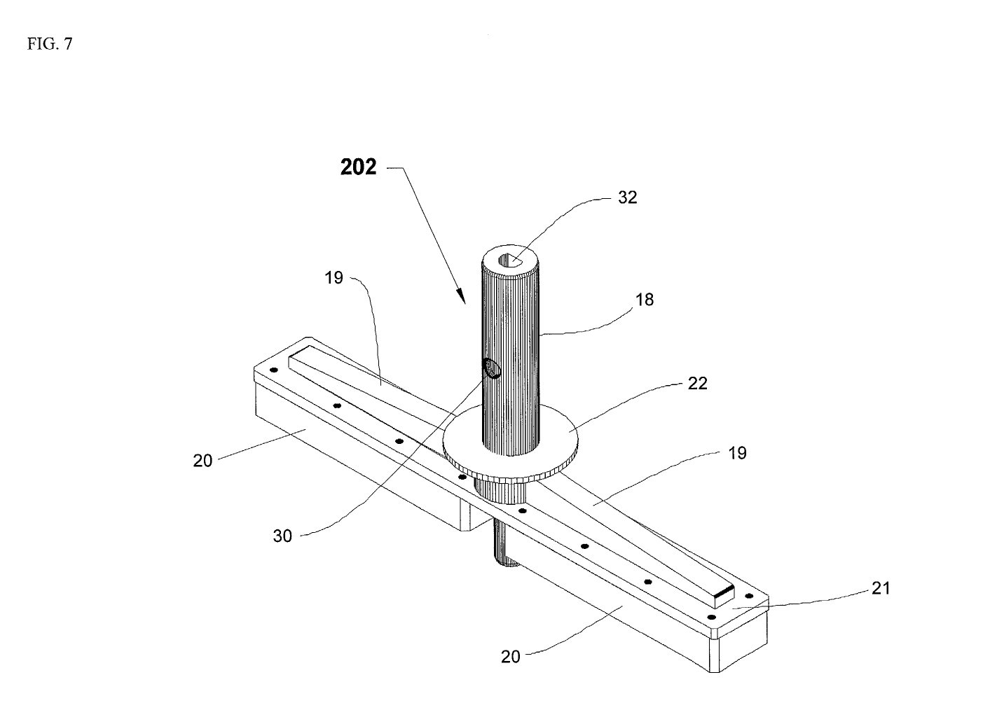

The first stage of the three-stage embodiment of the invention includes a backwash collecting arm assembly as illustrated in FIG. 7 and generally indicated by the number 202. The backwash collecting arm assembly comprises a backwash collection shaft 18 (illustrated in FIG. 8), backwash flush channel members 19, backwash contact shoes 20, backwash contact shoe retaining arm 21, and a backwash coil spring retaining ring 22. The first stage of the three-stage embodiment of the invention also includes a cleaning arm assembly as illustrated in FIG. 5 and generally indicated by the number 201. The cleaning arm assembly comprises a cleaning fluid shaft 23 (illustrated in FIG. 6), cleaning flush channel members 24, cleaning contact shoes 25, cleaning contact shoe retaining arm 26, and a cleaning coil spring retaining ring 51.

The cleaning contact shoes 25 are constructed of a material that allows them to sealingly and slidably abut the outlet side of the filter table 2. Delrin® or other suitable material may be used. A slotted opening 28 is provided in each cleaning contact shoe.

Similarly, the backwash contact shoes 20 are constructed of a material that allows them to sealingly and slidably abut the inlet side of the filter media coverplate 10. Delrin® or other suitable material may be used. A slotted opening (not illustrated) identical to the slotted opening in the cleaning contact shoe is provided in each backwash contact shoe 20. The backwash contact shoe retaining arm 21 is an elongate member extending the full diameter of the filter media coverplate 10 and with a center circular opening to receive the backwash collection shaft 18. Each end of the backwash contact shoe retaining arm 21 contains a slotted opening (not illustrated) which is of the same size as the slotted opening in the backwash contact shoe 20. The backwash contact shoes 20 are rigidly fixed to each end of the backwash contact shoe retaining arm 21 such that the slotted opening in the backwash contact shoe communicates with the slotted opening in each end of the backwash contact shoe retaining arm 21. The backwash flush channel members 19 are rigidly affixed to the backwash contact shoe retaining arm 21 and define a backwash flush channel which extends from the outer extent of the slotted opening of the backwash contact shoe retaining arm 21 radially inward.

The backwash collection shaft 18 is illustrated in FIG. 8. The backwash collection shaft comprises a backwash collection shaft cylinder 17 and a backwash collection shaft cap 29. The backwash collection shaft cylinder 17 is hollow at one end. A first backwash fluid outlet 30 provides an opening into the hollow cavity. A second backwash fluid outlet (not illustrated) is provided on the diametrically opposing side of the cylinder. At the end of the hollowed portion of the backwash collection shaft cylinder a first backwash flush inlet 31 is provided. The backwash flush inlet is constructed to receive one end of a backwash flush channel member 19. A second backwash flush inlet (not illustrated) is provided on the diametrically opposing side of the backwash collection shaft cylinder. The backwash collection shaft cap 29 is affixed to the hollowed end of the backwash collection shaft cylinder 17. The backwash collection shaft cap 29 and the backwash collection shaft cylinder 17 thus define a rigid conduit with a first and second backwash flush inlet at the end of the cylinder proximate the backwash collection shaft cap 29 and a first and second backwash flush outlet intermediate on the backwash collection shaft cylinder. The end of the backwash collection shaft cylinder opposite the backwash collection shaft cap is provided with an indexed sleeve opening 32. The backwash collection shaft cap includes a cylindrical extension of smaller diameter than the backwash collection shaft cylinder and which includes an indexed sleeve opening (not illustrated) identical to the indexed sleeve opening 32 of the backwash collection shaft cylinder.

Referring to FIG. 7, as previously described, the backwash contact shoes 20 are rigidly affixed to the backwash contact shoe retaining arm 21. The backwash flush channel members 19 are rigidly affixed to the opposing face of the backwash contact shoe retaining arm 21. The backwash collection shaft 18 extends through the central circular opening in the backwash contact shoe retaining arm such that one backwash flush channel member extends into the first backwash fluid inlet and the other backwash flush channel member extends into the second backwash fluid inlet. The backwash coil spring retaining ring is fitted over the backwash collection shaft abutting the backwash flush channel members and is rigidly affixed to the backwash collection shaft. Thus assembled, the backwash collection arm assembly provides a conduit for backwash fluid to pass from a slotted opening of a backwash contact shoe 20 through a slotted opening in the backwash retaining arm 21 and a channel defined by a backwash flush channel member 19 through a backwash fluid inlet in the backwash collection shaft and to an outlet in the backwash collection shaft.

The cleaning arm assembly, which is similar in construction to the backwash arm assembly previously described, is illustrated in FIG. 5. The cleaning contact shoe retaining arm 26 is an elongate member extending the full diameter of the filter table 2 and with a center circular opening to receive the cleaning fluid shaft 23. Each end of the cleaning shoe retaining arm 26 contains a slotted opening (not illustrated) which is of the same size as the slotted opening in the cleaning contact shoe 25. The cleaning contact shoes 25 are rigidly fixed to each end of the cleaning contact shoe retaining arm 26 such that the slotted opening in the cleaning contact shoe communicates with the slotted opening in each end of the cleaning contact shoe retaining arm 26. The cleaning flush channel members 24 are rigidly affixed to the cleaning contact shoe retaining arm 26 and define a cleaning flush channel which extends from the outer extent of the slotted opening of the cleaning contact shoe retaining arm 26 radially inward.

The cleaning fluid shaft 23 is illustrated in FIG. 6. The cleaning fluid shaft comprises a cleaning fluid shaft cylinder 33, a cleaning fluid shaft cap 34, and an indexed rotation transmission rod 35. The cleaning fluid shaft cylinder 33 is hollow at one end. A first cleaning fluid inlet 36 provides an opening into the hollow cavity. A second cleaning fluid inlet (not illustrated) is provided on the diametrically opposing side of the cylinder. At the end of the hollowed portion of the cleaning fluid shaft cylinder a first cleaning fluid outlet 37 is provided. The cleaning fluid outlet is constructed to receive one end of a cleaning flush channel member 24. A second cleaning fluid backwash flush outlet (not illustrated) is provided on the diametrically opposing side of the cleaning fluid shaft cylinder. The cleaning fluid shaft cap 34 is affixed to the hollowed end of the cleaning fluid shaft cylinder 33. The cleaning fluid shaft cap 34 and the cleaning fluid shaft cylinder 33 thus define a rigid conduit with a first and second cleaning fluid inlet intermediate on the cylinder and a first and second cleaning fluid outlet at the end of the cylinder proximate the cleaning fluid shaft cap 29. The end of the cleaning fluid shaft cylinder opposite the cleaning fluid shaft cap is provided with an indexed sleeve opening 66 (illustrated in FIG. 3). The cleaning fluid shaft cap includes a cylindrical extension with a diameter smaller than the cleaning fluid shaft cylinder which includes an indexed sleeve opening (not illustrated) identical to the indexed sleeve opening of the cleaning fluid shaft cylinder. An indexed rotation transmission rod 35 is slidably positioned in the indexed sleeve opening of the cleaning fluid shaft cap 34.

Referring to FIG. 5, as previously described, the cleaning contact shoes 25 are rigidly affixed to the cleaning contact shoe retaining arm 26. The cleaning fluid flush channel members 24 are rigidly affixed to the opposing face of the cleaning contact shoe retaining arm 26. The cleaning fluid shaft 23 (illustrated in FIG. 6) extends through the central circular opening in the cleaning contact shoe retaining arm such that the one cleaning fluid flush channel member extends into the first cleaning fluid outlet and the other cleaning fluid flush channel member extends into the second cleaning fluid outlet. The cleaning fluid coil spring retaining ring is fitted over the cleaning fluid shaft abutting the cleaning fluid flush channel members and is rigidly affixed to the cleaning fluid shaft. Thus assembled, the cleaning arm assembly provides a conduit for cleaning fluid to pass from an inlet intermediate the cleaning fluid shaft to a cleaning fluid outlet at the end of the shaft and to a cleaning fluid flush channel member, through a slotted opening in the cleaning contact shoe retaining arm 21 and out of the slotted opening in a cleaning contact shoe.

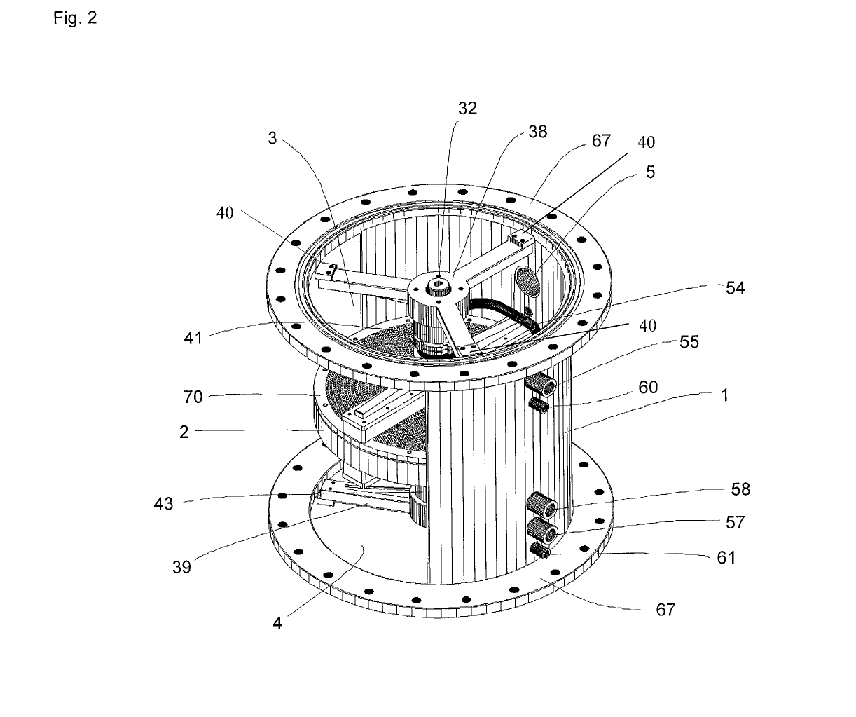

The first stage of the three-stage embodiment of the invention includes a top cross-sectional support member 38 and a bottom cross-sectional support member 39 as illustrated in FIG. 2. The top cross-sectional support member 38 includes a center annular portion with three support arms extending radially outward from the center annular portion. The support arms are rigidly affixed to support member mounting flanges 40 which extend inwardly from the cylindrical housing 1. Similarly, the bottom cross-sectional support member 39 includes a center annular portion with three support arms extending radially outward from the center annular portion. The support arms are rigidly affixed to support member mounting flanges 40 which extend inwardly from the cylindrical housing 1.

A backwash rejection chamber sleeve 41 is rigidly affixed to the center annular portion of the top cross-sectional support member. The backwash rejection chamber is defined by a cylindrical sleeve having an intermediate portion with an outside diameter greater than the outside diameter of each end. The inside diameter of the hollow sleeve portion of said intermediate portion is also greater than the inside diameter of the hollow sleeve portion on either end. As illustrated in FIG. 3, the backwash rejection chamber sleeve includes a backwash rejection outlet 42 on the larger intermediate portion.

Similarly, a cleaning fluid pressure chamber sleeve 43 is rigidly affixed to the center annular portion of the bottom cross-sectional support member. The cleaning fluid pressure chamber is defined by a cylindrical sleeve having an intermediate portion with an outside diameter greater than the outside diameter of each end. The inside diameter of the hollow sleeve portion of said intermediate portion is also greater than the inside diameter of the hollow sleeve portion on either end. As illustrated in FIG. 3, the cleaning fluid pressure chamber sleeve includes a cleaning fluid inlet 44 on the larger intermediate portion.

As illustrated in FIG. 3, the backwash collecting arm assembly 202 is positioned so that the backwash contact shoes 20 slidingly and sealingly abut the inlet side of the filter media coverplate 10. The backwash collection shaft 18 is received by the backwash rejection chamber sleeve 41 such that the first backwash flush outlet 30 and the second backwash flush outlet are positioned in the intermediate portion of the backwash rejection chamber sleeve 41 and so that the indexed sleeve opening 32 of the backwash collection shaft extends outward from the backwash rejection chamber sleeve 41 and through the opening of the center annular portion of the top cross-sectional support member 38. An upper backwash rejection chamber sleeve seal 45 and a lower backwash rejection chamber sleeve seal 46 rotatably and sealingly retain the backwash collection shaft within the backwash rejection chamber sleeve 41.

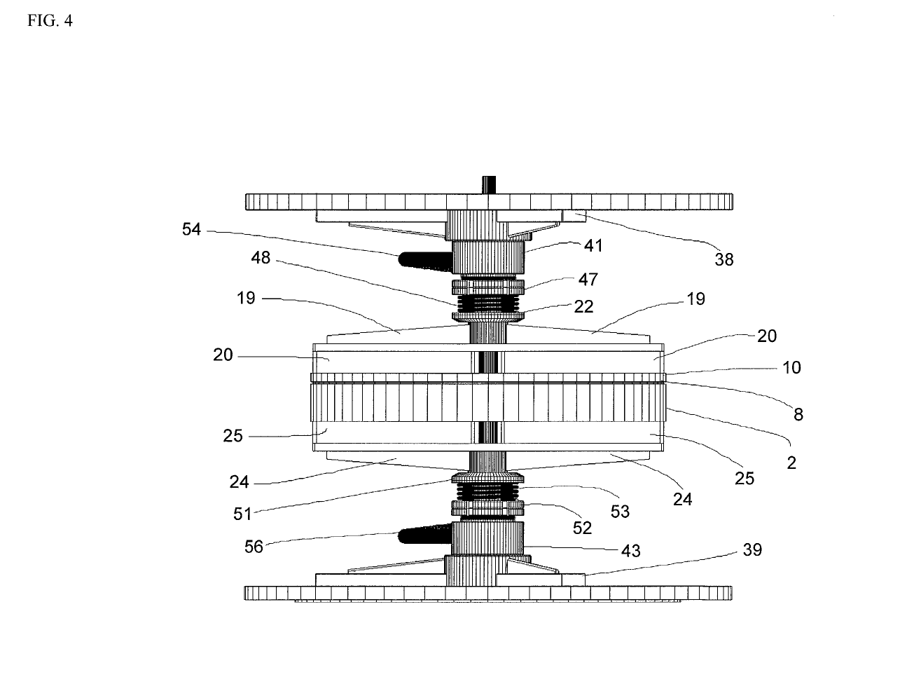

The portion of the backwash rejection chamber sleeve 41 proximate the backwash coil spring retaining ring 22 is threaded to receive a backwash collecting arm assembly adjusting nut 47, as illustrated in FIG. 4. A coil spring 48 is positioned to bias the backwash collecting arm assembly against the filter media coverplate 10. Those skilled in the art will appreciate that the adjusting nut 47 can be positioned to increase or decrease the pressure of the backwash contact shoes 20 against the filter media coverplate 10 so that the seal between the shoes and coverplate remains intact.

As illustrated in FIG. 3, the cleaning arm assembly 201 is positioned so that the cleaning contact shoes 25 slidingly and sealingly abut the outlet side of the filter table 2. The cleaning fluid shaft 23 is received by the cleaning fluid pressure chamber sleeve 43 such that the first cleaning fluid inlet 36 and the second cleaning fluid inlet are positioned in the intermediate portion of the cleaning fluid pressure chamber sleeve 43 and so that the indexed sleeve opening of the cleaning fluid shaft cylinder 33 extends outward from the cleaning fluid pressure chamber sleeve 43 and through the opening of the center annular portion of the bottom cross-sectional support member 39. An upper cleaning fluid pressure chamber sleeve seal 50 and a lower cleaning fluid pressure chamber sleeve seal 49 rotatably and sealingly retain the cleaning fluid shaft 23 within the cleaning fluid pressure chamber sleeve 43.

The portion of the cleaning fluid pressure chamber sleeve 43 proximate the cleaning coil spring retaining ring 51 is threaded to receive a cleaning arm assembly adjusting nut 52, as illustrated in FIG. 4. A coil spring 53 is positioned to bias the cleaning arm assembly against the filter table 2. Those skilled in the art will appreciate that the adjusting nut 52 can be positioned to increase or decrease the pressure of the backwash contact shoes 20 against the filter media coverplate 10 so that the seal between the shoes and coverplate remains intact.

The cleaning fluid shaft cap 34 extends upward through the center opening of the filter table 2. The backwash collection shaft cap 29 similarly extends through the filter media coverplate 10 such that the indexed sleeve opening of the backwash collection shaft cap 29 is slidably engaged by the indexed rotation transmission rod 35 extending from the cleaning fluid shaft cap. The indexed rotation transmission rod and the indexed sleeves are configured so that these may only be engaged when the cleaning contact shoes 25 are rotated to a position opposite the backwash contact shoes 20.

The indexed sleeve opening 32 of the backwash collection shaft cylinder 17 extends upward through the center annular portion of the top cross-sectional support member 38 and is slidably engaged by the indexed drive shaft 15. The indexed sleeve opening of the cleaning fluid shaft cylinder 33 extends through the center annular portion of the bottom cross-sectional support member 39 and provides for the second stage backwash collection shaft cylinder and the first stage cleaning fluid shaft cylinder to be engaged by an indexed rotation transmission rod.

Referring to FIG. 1, flexible conduit 54 connects the backwash rejection outlet 42 of the backwash rejection chamber 41 with a rejected backwash outlet 55 through the cylindrical housing 1 on the inlet side of the filter media coverplate 10. Flexible conduit 56 connects the cleaning fluid inlet 44 with a pressurized cleaning fluid inlet 57 through the cylindrical housing 1 on the outlet side of the filter table 2. A filtered fluid outlet 58 is provided through the cylindrical housing 1 on the outlet side of the filter table 2. The filtered fluid outlet 58 is connected by tubing to the suction side of the first stage booster pump 59 which is capable of boosting the pressure of the filtered fluid to 120 PSI. The pressurized outlet of the booster pump is connected by tubing to the cleaning fluid inlet 57.

An inlet chamber data port 60 extends through the cylindrical housing 1 on the inlet side of the filter media coverplate 10. An outlet chamber data port 61 also extends through the cylindrical housing 1 on the outlet side of the filter table 2. These data ports permit the pressure of the unfiltered fluid in the inlet chamber 3 and the pressure of the filtered fluid in the outlet chamber 4 to be measured by a transducer or other suitable monitoring device.

It should be appreciated by those skilled in the art that the second and third stages of the three-stage embodiment of the invention are substantially similar to the first stage of the three-stage embodiment. The outlet chamber 4 of the first stage communicates directly with the inlet chamber 62 of the second stage. Similarly, the outlet chamber 63 of the second stage communicates directly with the inlet chamber 64 of the third stage. Cylindrical housing mounting flanges 67 allow the filter lid housing to be fastened to the first stage by suitable fasteners such as nuts and bolts. The cylindrical housing mounting flanges also permit the first stage to be affixed to the second stage and the second to the third stage. The third stage of the three-stage embodiment of the invention illustrated in FIG. 1 is affixed to a filtered fluid basin 68 which contains a filtered fluid outlet 59 for the discharge of filtered fluid. A choke valve (not illustrated) can be provided at the outlet to ensure that sufficient filtered fluid remains in the outlet chamber 65 of the third stage to be used in the pressurized backwash of the third stage filter media.

As referred to earlier, the indexed sleeve opening of the first stage cleaning fluid shaft cylinder 33 which extends through the center annular portion of the bottom cross-sectional support member 39 of the first stage provides for a connection by an indexed rotation transmission rod to the indexed sleeve opening of the backwash collection shaft cylinder of the second stage which extends upward through the center annular portion of the top cross-sectional support member of the second stage. Similarly, the indexed sleeve opening of the second stage cleaning fluid shaft cylinder which extends through the center annular portion of the bottom cross-sectional support member of the second stage provides for a connection by an indexed rotation transmission rod to the indexed sleeve opening of the backwash collection shaft cylinder of the third stage which extends upward through the center annular portion of the top cross-sectional support member of the third stage it should also be appreciated by those skilled in the art that although the backwash collection arm assembly and corresponding cleaning arm assembly illustrated in the first stage of the three-stage embodiment of the invention is illustrated here with 2 arms, that a backwash collection arm assembly and a corresponding cleaning arm assembly containing one, three or more arms could be utilized in an embodiment of the invention or in other stages of this three-stage embodiment.

In operation, unfiltered fluid is introduced through the inlet 5 into the inlet chamber until the pressure in the inlet chamber is in the range of 70 to 80 PSI. The unfiltered fluid passes through the openings in the filter media coverplate 10 and through the filter media 8 where suspended solids are intercepted and deposited on and in the filter media. The filtered fluid passes through the openings in the filter table 2 to the first stage outlet chamber 4.

The drive means is engaged such that the cleaning arm assembly 201 and backwash collecting arm assembly 202 rotate in synchrony at approximately 10 rpm. A portion of the filtered fluid in the outlet chamber, in the range of 2-10%, is suctioned by the booster pump and returned through the cleaning fluid inlet 57 to the cleaning fluid pressure chamber. The booster pump pressurizes the cleaning fluid to a pressure above the inlet pressure and in the range of 90-100 PSI. The cleaning fluid is forced through the cleaning fluid shaft, through the cleaning flush channels and from slotted openings on the cleaning contact shoes into the openings of the filter table. The pressurized cleaning fluid dislodges the separated solids deposited in and on the filter media. These solids and the pressurized backwash are forced through the openings in the filtered media coverplate and are collected in the slots of the backwash contact shoes. The backwash fluid and the solids are further forced through the backwash flush channel and the backwash collection shaft to the backwash rejection chamber. The solids and backwashed fluid are then discharged from the filter through the backwash rejection outlet. Because the pressure of the pressurized filtered fluid is in excess of the fluid pressure in the inlet, unfiltered fluid cannot short-circuit the filter.

The pressure of the inlet chamber and the outlet chamber for each stage is continually monitored. A pressure differential of approximately 10 PSI in the first stage of the apparatus should be appreciated during operation. When the pressure differential between inlet and outlet chamber exceeds a preset value, the boosted pressure of the cleaning fluid and/or the rotation speed of the backwash collection arm assembly and the cleaning arm assembly are increased. In this fashion the cleaning action of the continuous backwash is increased. While increasing the rotational speed of the apparatus will increase the cleaning action at every stage, each stage of the device is provided with an independently controlled booster pump so that the pressure of the cleaning fluid in any stage can be adjusted independent of the pressure in other stages.

It should also be appreciated by those skilled in the art that rotational speed adjustments and booster pump pressure adjustments could be made automatically by suitable automatic control means.

The present invention has been disclosed with respect to a limited number of embodiments. Those skilled in the art will appreciate numerous modifications and variations from the embodiments described. It is intended that the claims herein cover those modifications and variations falling within the spirit and scope of the present invention.

1. A filter apparatus for separating solids from a fluid, comprising:
a filter housing comprising an inlet chamber having an inlet for the introduction of unfiltered fluid into the inlet chamber and having a volume of unfiltered fluid therein, and an outlet chamber having an outlet permitting discharge of filtered fluid from the outlet chamber and having a volume of filtered fluid therein;
a filter means located in said filter housing and rigidly supported between said inlet chamber and said outlet chamber; said filter means for intercepting solids from an unfiltered fluid containing solids; said filter means having an inlet side and an outlet side opposing said inlet side;
a pump means for receiving filtered fluid from the outlet chamber and for pressurizing said filtered fluid; said pump means having a pressurized fluid outlet;
a backwashing shoe means for backwashing said pressurized filtered fluid through a portion of said filter means, said backwashing shoe means arranged on said outlet side of the filter means and engaging a portion of said outlet side of the filter means; said backwashing shoe means connected to said pressurized fluid outlet of the pump means to receive pressurized filtered fluid from said pump means;
a backwashed fluid collection shoe means for collecting backwashed fluid and solids dislodged from said filter means and for discharging backwashed fluid and said solids and wherein said backwashed fluid collection shoe means is arranged on said inlet side of the filter means and aligned opposing said backwashing shoe means; said backwashed fluid collection shoe means engaging a portion of said inlet side of the filter means equal in area to the area of the portion of said outlet side of the filter means engaged by said backwashing shoe means;
a synchronized actuator means for causing movement of said backwashing shoe means and synchronous movement of said backwashed fluid collection shoe means relative to said filter means; wherein at all times said backwashed fluid collection means is aligned opposing said backwashing shoe means; said filter means being cleaned with backwashed fluid only in the portion of said outlet side of said filter means engaged by said backwashing shoe means; said cleaning occurring simultaneously with filtering through the remaining portion of said filter means; wherein all of said filter means is cleaned by said synchronized movement successively moving said backwashing shoe means over the entire surface area of said inlet side of the filter means and the backwashed fluid collection means over the entire surface area of said outlet side of the filter means.

2. The filter apparatus of claim 1 wherein said pump means pressurizes said pressurized filtered fluid to a fluid pressure in excess of the fluid pressure in said inlet chamber.

3. The filter apparatus of claim 1 wherein said pump means is controllable to control the fluid pressure of said pressurized filtered fluid delivered to said backwashing shoe means.

4. The filter apparatus of claim 1 wherein said synchronized actuator means is controllable to control the rate of synchronized movement of said backwashing shoe means and said backwashed fluid collection shoe means.

5. The filter apparatus of claim 3 further comprising a pressure sensing means for detecting the difference in fluid pressure between said inlet chamber and said outlet chamber and for detecting the pressure of said pressurized filtered fluid delivered to said backwashing shoe means by said pump means, said pressure sensing means adapted to communicate with said pump means.

6. The filter apparatus of claim 5 wherein said pressure sensing means is operable to operate said pump means to increase the fluid pressure of said pressurized filtered fluid delivered to said backwashing shoe means by a predetermined amount when the difference in fluid pressure between said inlet chamber and said outlet chamber exceeds a preset limit.

7. The filter apparatus of claim 3 wherein said synchronized actuator means is controllable to control the rate of synchronized movement of said backwashing shoe means and said backwashed fluid collection shoe means.

8. The filter apparatus of claim 7 further comprising a sensing means for detecting the difference in fluid pressure between said inlet chamber and said outlet chamber and for detecting the pressure of said pressurized filtered fluid delivered to said backwashing shoe means by said pump means and for sensing the rate of synchronous movement of said backwashing shoe means and said backwashed fluid collection shoe means, said sensing means adapted to communicate with said pump means and with said synchronized actuator means.

9. The filter apparatus of claim 8 wherein said sensing means is operable to operate said pump means to increase the fluid pressure of said pressurized filtered fluid delivered to said backwashing shoe means by a predetermined amount when the difference in fluid pressure between said inlet chamber and said outlet chamber exceeds a preset limit.

10. The filter apparatus of claim 9 wherein said sensing means is further operable to operate said synchronized actuator means to increase the rate of synchronized movement of said backwashing shoe means and said backwashed fluid collection shoe means to a predetermined rate when the difference in fluid pressure between said inlet chamber and said outlet chamber exceeds a preset limit.

11. A filtering apparatus for separating solids from a liquid, comprising
a cylindrical filter housing having an inlet for the introduction of unfiltered fluid on one end of said cylindrical housing and an having an outlet permitting discharge of filtered fluid on the opposing end of said cylindrical housing;
a rotation drive shaft disposed along the longitudinal axis of said cylindrical filter housing and supported therein;
an annular filter means disposed intermediate said cylindrical filter housing and rigidly supported therein and having a central opening, said rotation drive shaft sealingly and rotatably disposed through the central opening of said annular filter means; said annular filter means defining an inlet chamber in fluid communication with said inlet and defining an outlet chamber in fluid communication with said outlet; said annular filter means for intercepting solids from a liquid containing solids; said annular filter means having an inlet side and an outlet side; said inlet chamber being in fluid communication with said outlet chamber through said filter means;
a pump means in fluid communication with said outlet chamber for receiving filtered fluid from the outlet chamber and for pressurizing said filtered fluid;
said pump means having a pressurized fluid outlet;
a pressurized filtered fluid housing comprising an elongate pressurized filtered fluid hood having a pressurized filtered fluid inlet therein; said pressurized filtered fluid housing mounted for rotation about the longitudinal axis of said cylindrical filter housing and connected to said rotation drive shaft; said pressurized filtered fluid hood comprising at least one cleaning shoe; said cleaning shoe slidably and sealingly engaged with a portion of said outlet side of the annular filter means; said cleaning shoe having a radially extending slit therethrough which provides fluid communication between a substantial radially elongate area on said outlet side of the annular filter means and an interior of said pressurized filtered fluid housing wherein the interior of said pressurized filtered fluid housing is separated from said outlet chamber; said pressurized filtered fluid inlet connected by conduit to the pressurized fluid outlet of the pump means;
a backwashed fluid housing comprising an elongate backwashed fluid hood having a backwashed fluid outlet for discharging backwashed fluid and solids out of said cylindrical filter housing; said backwashed fluid housing connected to said rotation drive shaft and mounted for rotation about the longitudinal axis of said cylindrical filter housing in synchrony with said pressurized filtered fluid housing; said backwashed fluid hood comprising a number of backwash shoes equal to the number of cleaning shoes; each said backwash shoe slidably and sealingly engaged with a portion of said inlet side of the annular filter means and aligned opposing a cleaning shoe; each said backwash shoe having a radially extending slit therethrough which provides fluid communication between a substantial radially elongate area on said inlet side of the annular filter means and an interior of said backwashed fluid housing wherein the interior of said backwashed fluid housing is separated from said inlet chamber and wherein there is fluid communication between the radially extending slit of each said cleaning shoe through a substantial radially elongate area of the annular filter means and with the radially elongate slit on each said opposing backwash shoe;
a drive means connected to said rotation drive shaft for providing rotation of said rotation drive shaft, wherein rotation of said drive shaft causes rotation of said pressurized filtered fluid housing and said backwashed fluid housing around the longitudinal axis of the cylindrical filter housing and wherein said annular filter means is cleaned by backwashed pressurized filtered fluid in the area covered by said cleaning shoe and the opposing backwash shoe, cleaning occurring simultaneously with filtering over the remainder of the surface of the annular filter means, the entire annular filter means being washed successively during each completed revolution of said rotation drive shaft.

12. The filter apparatus of claim 11 wherein said pump means pressurizes said pressurized filtered fluid to a fluid pressure in excess of the fluid pressure in said inlet chamber.

13. The filter apparatus of claim 11 wherein said pump means is controllable to control the fluid pressure of said pressurized filtered fluid delivered to said pressurized filtered fluid inlet of said pressurized filtered fluid hood.

14. The filter apparatus of claim 11 wherein said drive means is controllable to control the rate of movement of said pressurized filtered fluid housing and said backwashed fluid housing.

15. The filter apparatus of claim 13 further comprising a pressure sensing means for detecting the difference in fluid pressure between said inlet chamber and said outlet chamber and for detecting the pressure of said pressurized filtered fluid delivered to said pressurized filtered fluid inlet of said pressurized filtered fluid hood by said pump means, said pressure sensing means adapted to communicate with said pump means.

16. The filter apparatus of claim 15 wherein said pressure sensing means is operable to operate said pump means to increase the fluid pressure of said pressurized filtered fluid delivered to said pressurized filtered fluid inlet of said pressurized filtered fluid hood by a predetermined amount when the difference in fluid pressure between said inlet chamber and said outlet chamber exceeds a preset limit.

17. The filter apparatus of claim 13 wherein said drive means is controllable to control the rate of movement of said pressurized filtered fluid housing and said backwashed fluid housing.

18. The filter apparatus of claim 17 further comprising a sensing means for detecting the difference in fluid pressure between said inlet chamber and said outlet chamber and for detecting the pressure of said pressurized filtered fluid delivered to said pressurized filtered fluid inlet of said pressurized filtered fluid hood by said pump means and to detect the rate of movement of said pressurized filtered fluid housing and said backwashed fluid housing, said sensing means adapted to communicate with said pump means and with said drive means.

19. The filter apparatus of claim 18 wherein said sensing means is operable to operate said pump means to increase the fluid pressure of said pressurized filtered fluid delivered to said pressurized filtered fluid inlet of said pressurized filtered fluid hood by a predetermined amount when the difference in fluid pressure between said inlet chamber and said outlet chamber exceeds a preset limit.

20. The filter apparatus of claim 19 wherein said sensing means is further operable to operate said drive means to increase the rate of movement of said pressurized filtered fluid housing and said backwashed fluid housing to a predetermined rate when the difference in fluid pressure between said inlet chamber and said outlet chamber exceeds a preset limit.

21. A method of filtering solids from a fluid and backwashing a filter comprising passing unfiltered fluid from an intake fluid volume through a filter element to an outlet fluid volume to filter solids from said unfiltered fluid and deposit said solids on and in said filter element;
providing a pressurized filtered fluid housing disposed on the outlet side of said filter element and having a slot arrangement arranged to engage a portion of said filter element;
providing a backwashed fluid housing disposed on the inlet side of said filter element opposing said pressurized filtered fluid housing and having a slot arrangement arranged to engage said portion of said filter element wherein there is fluid communication between said pressurized filtered fluid housing through said portion of said filter element and to said backwashed fluid element;
suctioning a portion of filtered fluid from the outlet fluid volume;
pressurizing said portion of suctioned filtered fluid to a pressure in excess of the fluid pressure of the intake fluid volume;
passing said pressurized filtered fluid through said pressurized filtered fluid housing to backwash solids from said filter element;
collecting backwashed fluid and solids through said backwashed fluid housing;
discharging said backwashed fluid and solids;
producing synchronous movement of said pressurized filtered fluid housing and said backwashed fluid housing relative to said filter element so that pressurized filtered fluid is passed through said pressurized filtered fluid housing and through portions of said filter element to said backwash fluid housing to backwash solids collected on said fluid element.

22. The method of claim 21 further comprising
sensing the difference in fluid pressure between said intake fluid volume and said outlet fluid volume;
increasing the pressure of the pressurized filtered fluid passed through said pressurized filtered fluid housing to backwash solids from said filter element when said difference in fluid pressure between the intake fluid volume and the outlet fluid volume exceeds a predetermined amount.

23. The method of claim 22 further comprising
increasing the rate of synchronous movement of said pressurized filtered fluid housing and said backwashed fluid housing relative to said filter element when said difference in fluid pressure between the intake fluid volume and the outlet fluid volume exceeds a predetermined amount.
